(19) United States
(12) Patent Application Publication
(10) Pub. No.: US 2008/0064019 A1
(43) Pub. Date: Mar. 13, 2008

(54) INTERACTIVE INTERNET BASED SYSTEM FOR SELF-ASSESSMENT AND SELF-IMPROVEMENT

(76) Inventors: Scott M. Kaufman, Marina del Rey, CA (US); Jennifer L. Kushell, Marina del Rey, CA (US); Russell J. Watson, Oswego, IL (US); Robert M. Cohen, Ashland, MA (US); Joshua T. Hoppes, Santa Ana, CA (US)

Correspondence Address: MARC E. HANKIN, ESQ., 11414 THURSTON CIRCLE, LOS ANGELES, CA, 90049, US

(21) Appl. No.: 11/530,903

(22) Filed: Sep. 12, 2006

(51) Int. Cl. G09B 3/00

(52) U.S. Cl. 434/350

(57) ABSTRACT

An internet based system for conducting self-assessment and self-improvement inquiries, including expert and peer evaluations, advisement, and support within the context of an internet based dynamic and interactive online community designed to further the self-assessment and self-improvement process by providing users with computer based self-assessment and self-improvement tests utilizing a dynamic flash based “video-game-like” interface and, then providing the results to be used within that interactive online community to further the self-improvement process by the participation in an internet-based online community in which the user is matched with actual online resources with aptitudes and preferences as determined by the results of the directed self-assessment. Said results may also be used to match vocational and avocational aptitudes with the potential employers and mentors of the social community.

### FIELD OF INVENTION

This invention relates, generally, to systems for self-assessment and self-improvement; more particularly, to internet based systems for self-assessment and self-improvement as a gateway into an interactive online community that matches actual online resources with aptitudes and preferences as determined by the self-assessment results.

### BACKGROUND

The recent improvements in information technology and computer based communications have allowed widespread improvements in methods and systems for testing and self-assessment. Numerous systems, such as the system disclosed by U.S. Pat. No. 6,272,467 to Durand et al., disclose computer based systems that collect and evaluate user data. Durand's patent, for example, discloses a computer based system for collecting preference data from users and ranking matches in a database for the users based on the preference data selected by the users. In this manner, Durand discloses a computer based means for simplifying dating, job-placement, and other such processes. Like Durand's system, U.S. Pat. No. 6,735,568 to Buckwalter et al. discloses a computer based system for identifying people who are likely to have a successful relationship based upon user-entered preference data, as used on the internet web site www.eHarmony.com.

Another such system is disclosed by U.S. Pat. No. 6,658,391 to Williams et al., which discloses a computer based apparatus for predicting the behavior of consumers based upon prior inputs of preference data of similarly situated consumers. Like the above system, statistical data is collected from user inputs in order to enhance predictions generated by the computer based system. Another system for generating computer based predictions is disclosed by U.S. Pat. No. 6,470,319 to Ryan, which uses assessment data, entered into a computer database, compared with demographic data, stored by a computer system, in order to generate a successful case management plan for criminal offenders.

In the area of education, computer based evaluation systems have similarly been developed in order to assist in knowledge assessment and learning. U.S. Pat. No. 6,921,268 to Bruno et al., for example, discloses a computer based testing system that generates test results as well as learning materials, which are tailored to weaknesses identified by the test results. Similarly, U.S. Pat. No. 6,816,702 to Kuntz et al. also discloses a computer based system for assessing student test scores for educational purposes. U.S. Pat. No. 6,295,439 to Bejar et al. discloses a system for computer analysis that is specifically tailored to evaluating the objectivity of test questions and human evaluators in test scores.

While the above systems disclose means for user computer based programs in order to evaluate various abilities, none of the above systems is directed towards a computer based system for career and aptitude evaluation, and none of the known systems matches actual online resources with aptitudes and preferences as determined by the self-assessment results.

Other systems, such as www.assessment.com, disclose computer based means for providing self-assessment tests. These on-line systems, however, generally provide and evaluate tests in the same manner that was performed in traditional multiple-choice, paper tests. Thus, they fail to offer the advantage of human evaluation or peer review, as part of the evaluation process. They further fail to allow the assessment results to be used in the context of an interactive online community or, more specifically, an interactive online community in the context of employment and hiring. Thus, the prior art assessment systems are “one-dimensional” in the sense that they fail to take advantage of recent advances in computers, information technology, and internet-based online communities.

Along with the evolution of these computer based systems, advances in information technology and the internet have rapidly increased the means for computer based socializing and networking. Internet websites, such as www.blogspot.com and www.myspace.com, have allowed internet users to meet and communicate with one another and to communicate based upon shared interests, as they are discovered and uncovered. These websites, however, are primarily geared towards socializing and social or political commentary. While they may result in some self-assessment and self-improvement, an efficient system for adapting these technologies for use in self-improvement and self-assessment has yet not been developed. None of the “social networks” on the internet at the time of the filing of this patent application are a true dynamic interactive online community that is comprised of people from across the globe in which participants are matched with actual online resources based upon their own aptitudes and preferences as determined by the self-assessment.

Thus, there remains a long felt need in the art for an internet and computer based self-improvement and self-assessment system that allows users the benefits of peer and expert advisement gained through the participation in an internet-based online community that match actual online resources with aptitudes and preferences as determined by the results of the directed self-assessment.

### SUMMARY OF THE INVENTION

One embodiment of the invention is directed towards overcoming the above shortcomings by disclosing an internet based system for conducting self-assessment and self-improvement, which improves upon the above prior art systems by including expert and peer advisement and support within the context of a interactive online community. Thus, the invention fulfills a long-felt need in the art by providing users with computer based self-assessment and self-improvement tests utilizing a dynamic flash based “video-game-like” interface and, moreover, allowing those assessment results to be used within an interactive online community to further the self-improvement process, in addition to facilitating the connection of potential employees to potential employers based on personality characteristics, skill aptitude, values, and desired corporate traits and work environment.

Users often turn to the prior art systems discussed above for self-assessment and self-improvement tests. Unfortunately, however, these assessment results are “one-dimensional” in the sense that, while they provide foundational guidance to the test-taker on interests and aptitude, they fail to provide resources or peer and expert advice that is tailored to the individual's needs. Thus, upon receiving test results from the prior art systems, the user is on his or her own to seek out networks, peers, experts, and other sources of information in order to benefit from the self assessment system results.

One embodiment of the invention improves upon these shortcomings by correlating the results of an online self-assessment with an online community of peers and experts that furthers the self-improvement process by providing further guidance and tutelage based upon the results of a dynamic, online “smart-test” that changes question components/choices later in the assessment based upon answers to earlier questions, in order to drill down deeper and to inquire specifically of that particular user taking the assessment, so that particular user gets choices and results that are personally applicable, and then that user can be directed to people and resources specifically relevant and helpful to that particular user. That is, after conducting an online self-assessment, a user is offered entry into a network of online users and provided with select contact information of specific other users with similar interests and aptitudes to those of the particular user. The community of online users post profiles related to their professional occupations, hobbies, interests, and other such information. They may also elect to post all or parts of the results of their self-assessment to enable like-minded users to seek out similarly like-minded users, but the novelty is that the protocol used does not rely on chance encounters, but rather directs a particular user to specific other users and resources already present within the particular user's internet-based online community based on the unique answers submitted by the user during the self assessment.

Thus, with the information generated by the resulting self-assessment report, the particular user is free to directly contact and interact with other users that may share insights and information on the particular user's results with communication and collaboration tools provided to users within the online community. Furthermore, through these contacts, the users can develop friendships, partnerships, companies and new interactive online community networks and sub-networks. For example, if a particular user's self-assessment results indicate an aptitude for becoming an engineer, he could interact with current professional and aspiring engineers who are members of the internet-based online community, so the particular user may learn more about different areas within the selected profession, to learn about means of preparing for becoming an engineer, and other such information. The particular user could also join groups of different kinds of engineers (aeronautical, chemical, electrical, industrial, structural, etc.), and other groups for persons of similar interests to interact and learn from peers and experts within the industry.

The results of the self-assessment may also be used as a means to develop and improve employer/employee relationships. Employees, for example, could use their self-assessment results as a means of seeking and contacting prospective employers. In one embodiment of the invention, employees may configure an automatic search and notifications system, identified by said assessment system results relating to ideal employment characteristics that enhance the system's functionality by constantly appraising users of new, potentially interesting corporate employer members. Employers, similarly, could use the self-assessment system as a means for finding and evaluating potential employees that meet their specific hiring criteria. In this manner, the invention also represents a substantial improvement over conventional employment websites because it combines assessment and personality tests as a fundamental gateway into a more dynamic discovery and collaboration process for the future employer as well as for the future employee.

Further, upon employers finding potential future employees with assessment results that match with the employer's desired hiring criteria profile, employers can browse the interactive online community to view additional details about the potential candidate through posted online profiles, and may use the system to contact the prospective employee to express an interest in learning more about the potential candidate based upon the candidate's assessment results and additional background information posted online. Further, multiple top performing current employees could be provided with the assessment online by a growing employer to yield a unique combined profile make-up that best meets that employer's desired employee hiring criteria/profile and said employer then could search the interactive online community to identify potential candidates who have self-assessment results that match its desired criteria. Also, the system can be used in reverse so that potential employee candidates can view and browse corporate profiles and reach out to participating companies who have posted ideal candidate assessment results to the interactive online community. None of these functionalities are known in the art, nor is there any known existing system that permits such flexibility in both directions.

In one embodiment of the invention, industry groups and categories are further specialized and separated into niches from these broader categories. In this fashion, the invention allows users particularity in narrowing their selection of peers, experts, and colleagues with whom to interact. The website features additional options that allow users to create one or more profiles that include their general demographical information, in addition to specific information on that particular user's professional and personal interests. Meanwhile, users can interact and communicate with other members via intra-site mail, live chat and posting messages on member boards. The invention may include a robust search mechanism for seeking out and contacting other members with similar professional and personal interests. Also, the invention may include one or more pages of industry specific libraries, containing information regarding particular industries and shared by the many users of the system.

In this manner, the invention discloses a means for conducting self-assessment and self-improvement that represents a vast improvement upon the prior art systems by incorporating peer and expert evaluations, advisement, mentoring and professional support within the context of an internet based interactive online community to further the self-assessment and self-improvement process.

### BRIEF DESCRIPTION OF THE DRAWINGS

FIG. 1 is a screen shot from an internet browser that has accessed the home page for one embodiment of the invention.

FIG. 2 is a screen shot from an internet browser that has accessed a member search screen for one embodiment of the invention.

FIG. 3 is a screen shot from an internet browser that has accessed a particular user's public profile page in one embodiment of the invention.

FIG. 4 is a screen shot from an internet browser that has accessed the main page for the YSN Self-Assessment System in one embodiment of the invention.

FIG. 5 is a screen shot from an internet browser that has accessed the starting page for the YSN Self-Assessment System in one embodiment of the invention.

FIG. 6 is a screen shot from an internet browser that has accessed one sample question page from the YSN Self-Assessment System in one embodiment of the invention.

FIG. 7 is a screen shot from an internet browser that has accessed the “Receptionist Lobby Page” from the YSN Self-Assessment System in one embodiment of the invention.

FIG. 8 is a screen shot from an internet browser that has accessed the “Magazine Rack Page” from the YSN Self-Assessment System in one embodiment of the invention.

FIG. 9 is a screen shot from an internet browser that has accessed “Jen's Executive Office” from the YSN Self-Assessment System in one embodiment of the invention.

FIG. 10 is a screen shot from an internet browser that has accessed the “Posting Board Page” from the YSN Self-Assessment System in one embodiment of the invention.

FIG. 11 is a screen shot from an internet browser that has accessed a single posting page from the YSN Self-Assessment System in one embodiment of the invention.

FIG. 12 is a screen shot from an internet browser that has accessed the “Penthouse With Smoothie Bar Scene” from the YSN Self-Assessment System in one embodiment of the invention.

FIG. 13 is a screen shot from an internet browser that has accessed the “Master Your Universe” screen from the YSN Self-Assessment System in one embodiment of the invention.

FIG. 14 is a screen shot from an internet browser that has accessed the “Smoothie Bar Selection Scene” from the YSN Self-Assessment System in one embodiment of the invention.

FIG. 15 is a screen shot from an internet browser that has accessed the “Smoothie Bar Selection Scene” from the YSN Self-Assessment System in one embodiment of the invention.

FIG. 16 is a screen shot from an internet browser that has accessed the “Conclusion Screen” from the YSN Self-Assessment System in one embodiment of the invention.

### DETAILED DESCRIPTION OF THE DRAWINGS

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the screen shot figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, “computer” refers to any device that processes information with an integrated circuit chip, including without limitation, mainframe computers, work stations, servers, desktop computers, portable computers, laptop computers, embedded computers, wireless devices including cellular phones, personal digital assistants, and portable game players, and hand-held computers; “internet” refers to any collection of networks using standard protocols, whether Ethernet, ATM, FDDI, Wi-fi, Token ring, or any combination thereof; and “website” refers to any document written in a mark-up language including, but not limited to, HTML (hypertext mark-up language) or VRML (virtual reality modeling language), dynamic HTML, XML (extended mark-up language), WML, or any other computer languages related thereto, as well as to any collection of such documents reachable through one specific Internet Protocol Address or at one specific World Wide Web site, or any document obtainable through any particular URL (Uniform Resource Locator); and “web page” refers to any of the various documents and resources on the World Wide Web, in HTML/XHTML format with hypertext links to enable navigation from one page or section to another, or similar such resources used on the internet.

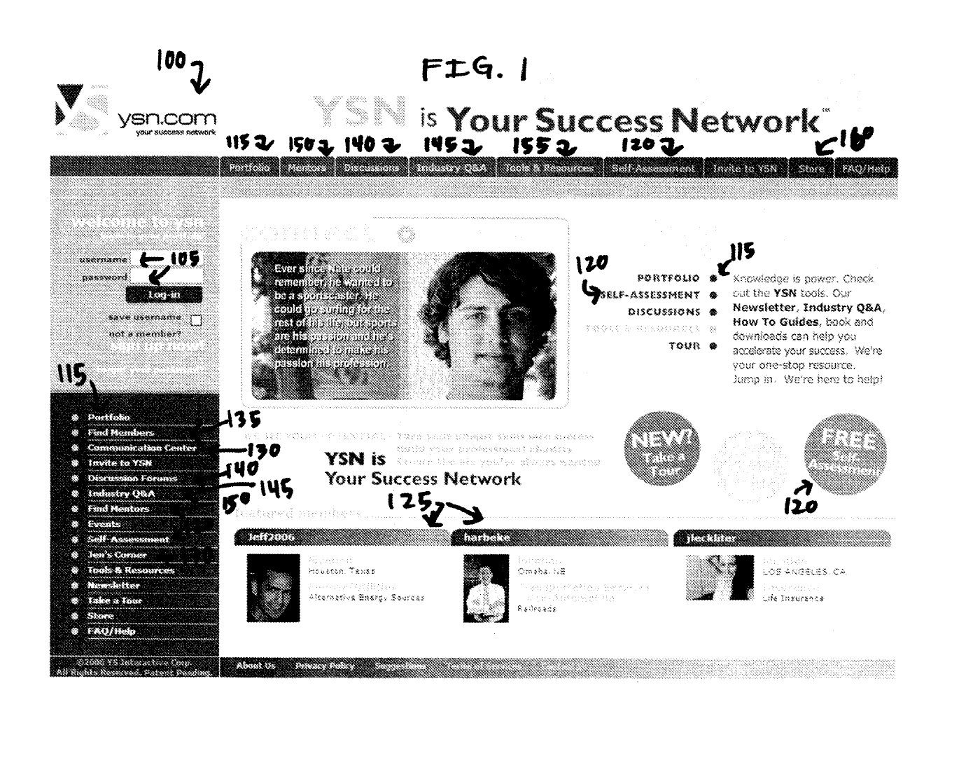

FIG. 1 is a screen shot from an internet browser that has accessed the home page for one embodiment of the invention. A web page 100 is shown that displays many of the constituent parts of the invention, some of which are described hereinbelow. Each user must log in using a username and password in the Log-in section 105. Each user and the public may access information that s/he has input into a location called a “portfolio” 110, and that information may be accessed from a variety of locations 115 on the home page (as well as on other internal pages). From the home page, a user may take a “self-assessment” that may be accessed from a variety of locations 120. The home page 100 also features links to a list of selected featured members 125. The home page 100 further features links for communication 130 among the users including intra-site messaging, live chat and the ability to post comments on the portfolio through the communication center 130; a link to access a mechanism to search for other members 135; a link to join discussion groups 140; a link to access a comprehensive industry specific library of questions and answers 145; a link to find mentors 150; a link to tools and resources 155; and other such links on a tool bar along the top of the page 160 and in a tool bar along the side of the page 170.

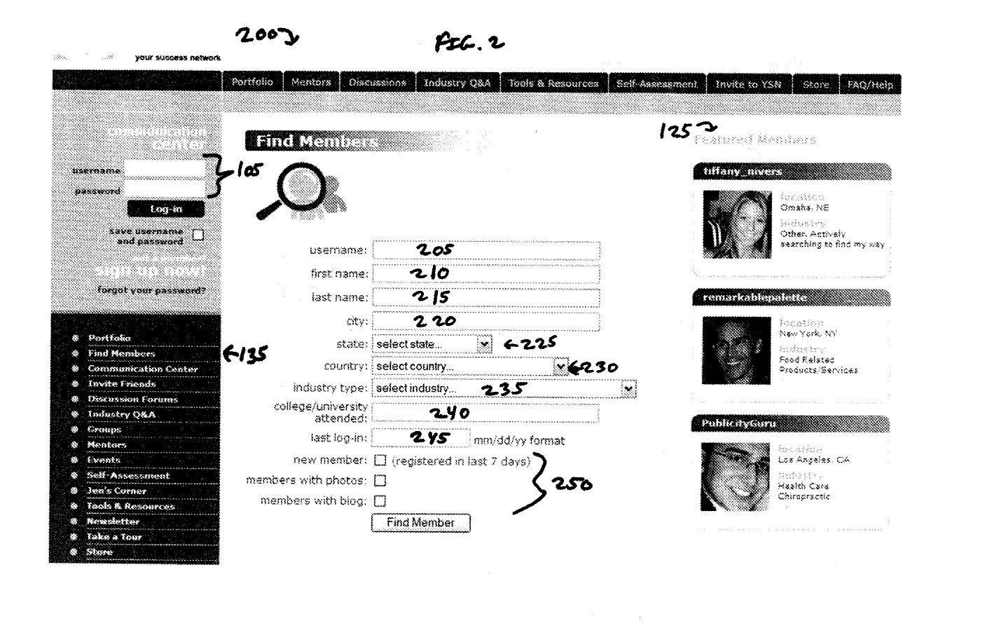

FIG. 2 is a screen shot from an internet browser that has accessed the mechanism to search for other members 135 in one embodiment of the invention. A web page 200 displays the searching mechanism that is used to find other members in one embodiment of the invention. The search mechanism allows users to search for other users with whom to communicate on the basis of their username 205, their first name 210, their last name 215, the city in which they reside 220, the state in which they reside 225, the country in which they reside 230, the industries 235 in which they work or in which they have worked, their college or university 240, their last log-in date 245, and other criteria 250. In this manner, the search mechanism of the present invention greatly improves upon prior art self-assessment mechanisms because the current invention allows users to use their own results and the results of others in order to locate and communicate with other online users with similar interests and/or aptitudes. What is more, the search tool allows career development to be merged with self-assessment because users are able to locate vocations based upon the interests identified by their self-assessment results, and also are able to identify and communicate with specific individuals in any such industry who is actually working in the field, or simply interested in working in said field, as identified by the particular user's results.

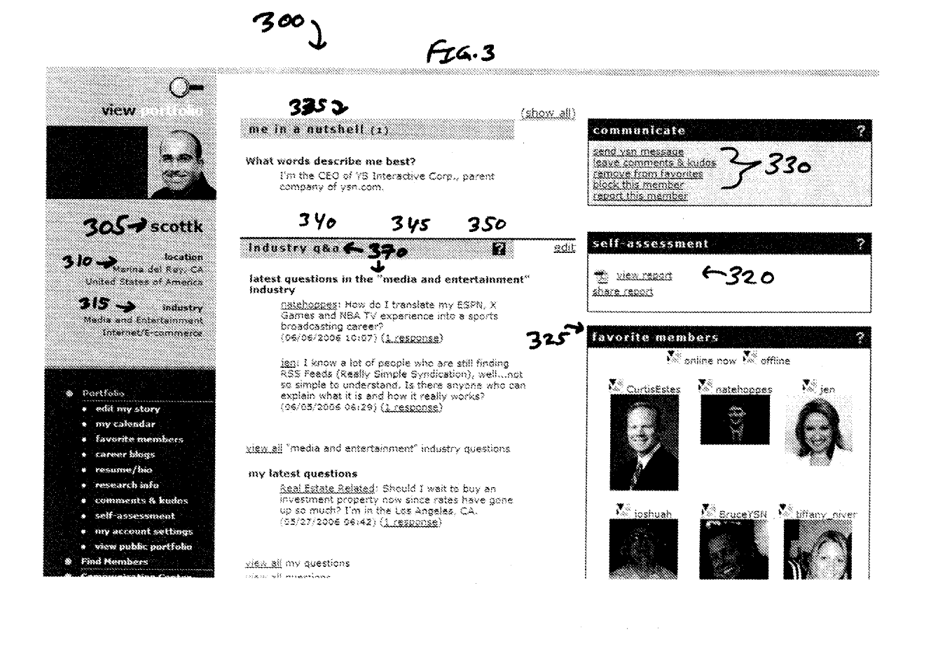

FIG. 3 is a screen shot from an internet browser that has accessed a particular user's profile page in one embodiment of the invention. A web page 300 is shown that displays some of the information related to a user's profile. For example, each profile features a username 305, location information 310, industry information 315, self-assessment test results 320, and a list of selected favorite other users 325. These and other profile categories allow users to locate and select other users to communicate with 330 based upon the various categorical information. In addition, the profile may include a summary of information on “me in a nutshell” 335, information on the user's life 340, the user's career 345, the user's preferences 350, and other such information. The user's profile page 300 features links for communication 330 among the users, a link to access a search mechanism 355, a link to join discussion groups 360, a link to access an industry specific industry library 365, and additional links. The user's profile page 300 also features Industry Q&A 370, and specific Q&A asked by specific other users, in which the particular user may be interested. This page enhances the self-assessment process because, first, users are able to input information regarding their personality in order that other users may contact and assist them. Second, users with particularized backgrounds can locate other such users to assist with their self-improvements assessments, career developments, and other such activities.

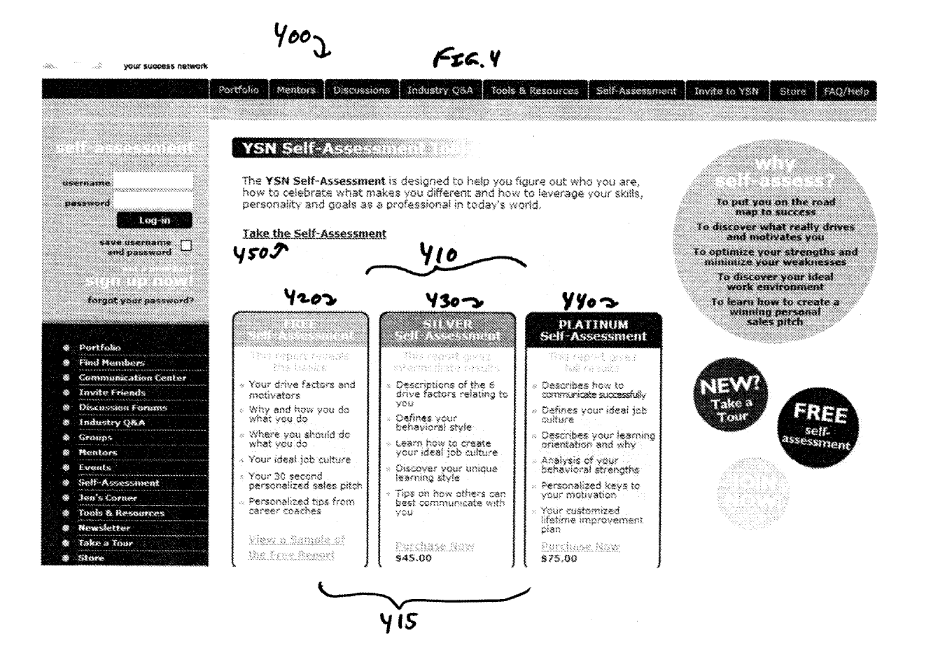

FIG. 4 is a screen shot from an internet browser that has accessed the main page for the YSN Self-Assessment System in one embodiment of the invention. A web page 400 is shown that displays three examples 410 of Self-Assessment that can be taken, with varying levels of Reports being generated depending on the amount of money the particular user is prepared to pay 415. The first (lowest) level is the Free Report 420. The middle level is the Silver Self-Assessment 430, while the highest level is the Platinum Self-Assessment 440. Each of these different levels provides the user with different benefits, relative to the other levels. Once the user has decided which level or Report s/he would like to order initially, the user may click on the link to take the Self-Assessment 450.

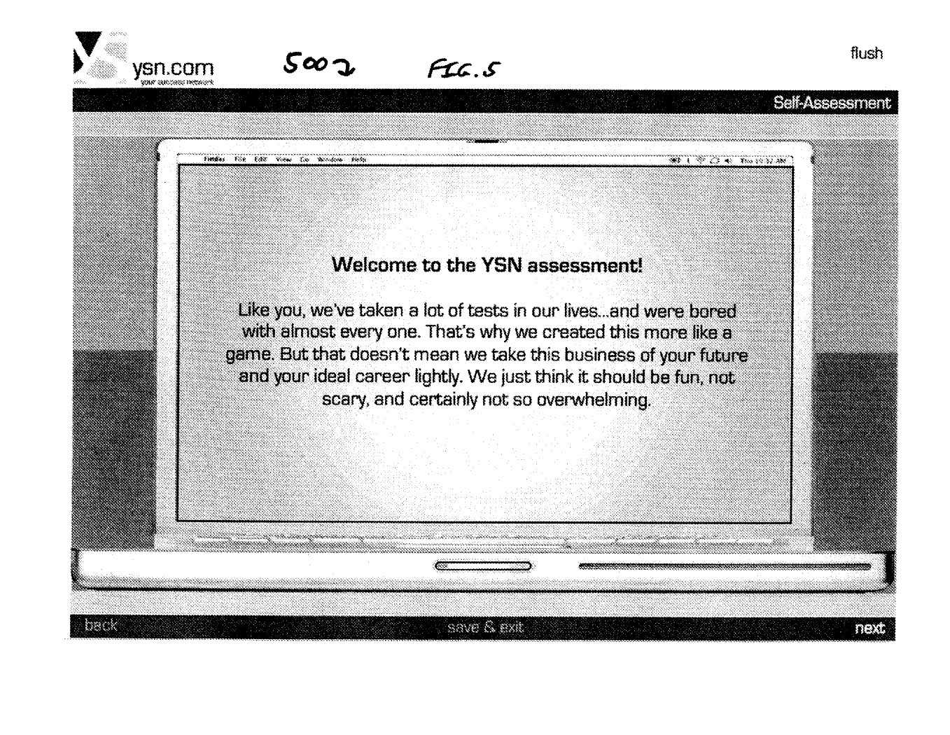

FIG. 5 is a screen shot from an internet browser that has accessed the starting page 500 for the YSN Self-Assessment System in one embodiment of the invention.

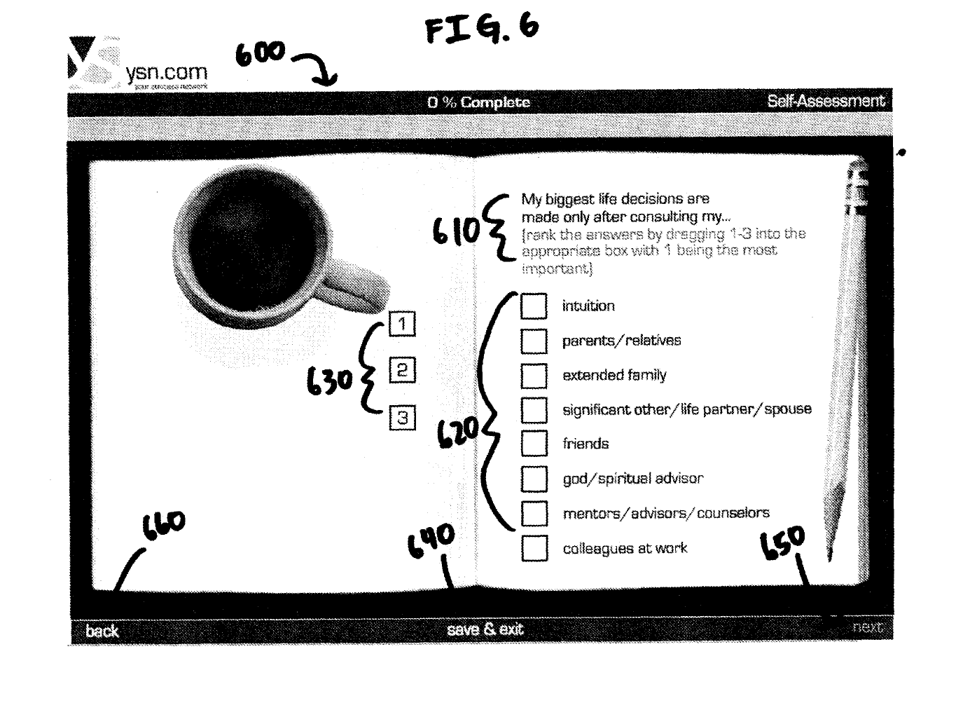

FIG. 6 is a screen shot from an internet browser that has accessed one sample question page 600 from the YSN Self-Assessment System in one embodiment of the invention. Each of the question pages in the Self-Assessment System has three main components: a question or statement (often with instructions) 610; answer choices 620, often represented as empty boxes to select or into which to drag and drop rank-ordinals, similar to a video game; and rank-ordinals 630, often 3, or 4, but sometimes another amount of numbers, to be dragged and dropped in the proper place as determined by that particular user. In addition, on most of the pages of the Self-Assessment, there are three navigation buttons at the bottom of the screen, one that will enable a busy user to “Save & Exit” 640, able to return later to complete the Self Assessment; a “Next” button 650, to advance to the next screen; and a “Back” button 660, to return to a prior screen.

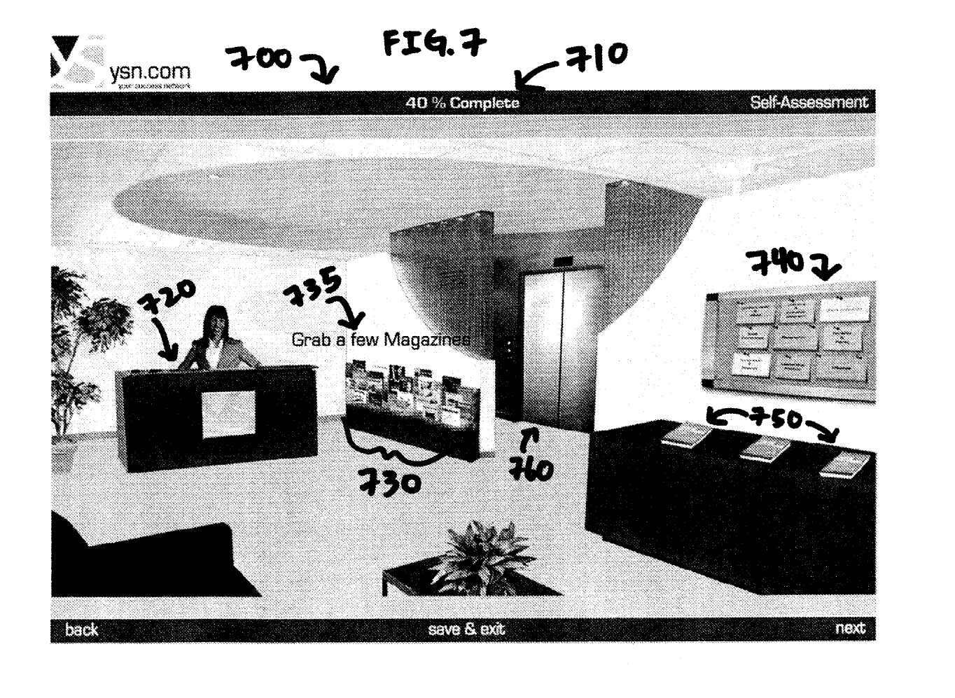

FIG. 7 is a screen shot from an internet browser that has accessed the “Receptionist Lobby Page” 700 from the YSN Self-Assessment System in one embodiment of the invention. On most screens, there is an indicator 710 that lets the user know how far along in the Self-Assessment that particular user is at any particular screen. On the “Receptionist Lobby Page” 700 there is a Receptionist Desk 720 from which instructions may be given. In the Lobby, there is a Magazine Rack 730, a Posting Board 740, and a table with copies of the book, Secrets of the Young & Successful 750. There is also an elevator 760 that can “take the user to another floor” for other activities. As part of the video-game-like interface, and to keep the user from getting lost, there are, at critical moments throughout the Self-Assessment, instructional statements 735 designed to give the user direction as to where to go next.

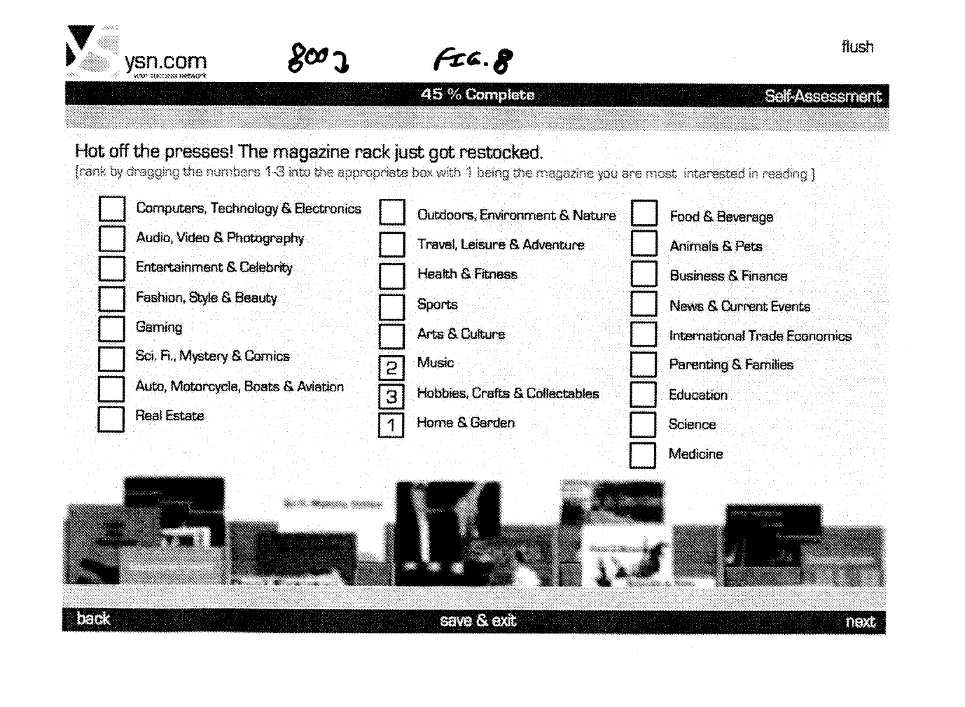

FIG. 8 is a screen shot from an internet browser that has accessed the “Magazine Rack Page” 800 from the YSN Self-Assessment System in one embodiment of the invention, on which the user selects his or her top choice topics as if they were titles of a magazine.

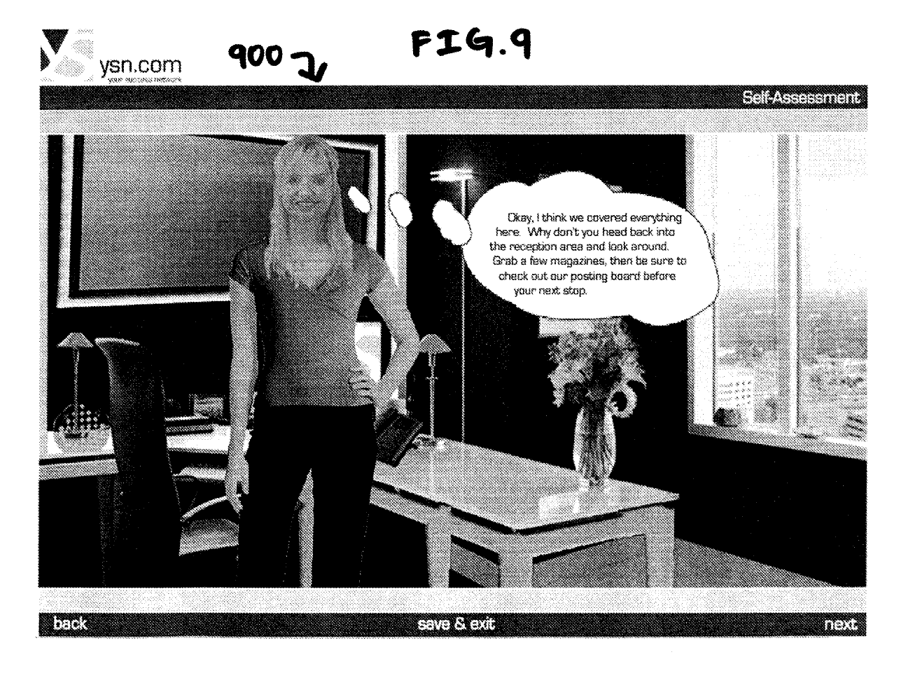

FIG. 9 is a screen shot from an internet browser that has accessed “Jen's Executive Office” screen 900 from the YSN Self-Assessment System in one embodiment of the invention. Throughout the Self-Assessment there are landing pages on which information can be conveyed to the user, and at which the user may take stock of where s/he has been thus far. These pages are designed to evoke certain emotions and to convey certain information as part of the plot of the video-game-like interface of the Self-Assessment System. In this scene, for example, Jen takes the user though an interview of how they view themselves.

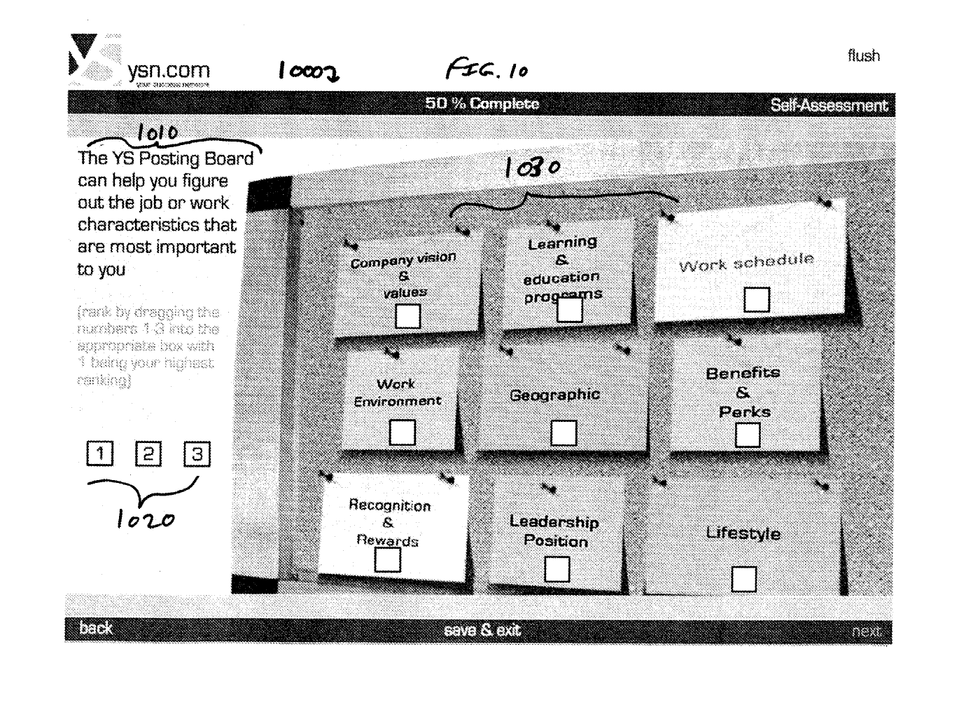

FIG. 10 is a screen shot from an internet browser that has accessed the “Posting Board Page” 1000 from the YSN Self-Assessment System in one embodiment of the invention. This page, another off-shoot from the “Receptionist Lobby Page” has additional questions and statements. There are instructions 1010, rank-ordinals 1020, and characteristics to be rank-ordered 1030, in the nature of notes on a bulletin board. The next few slides will vary in the actual invention, as implemented, because in the real Self-Assessment, they are selected and prioritized according to the user's specific choices. Subsequent questions within the Self-Assessment are selected for a given particular user based upon that particular user's own specific answers to the prior questions in the Self-Assessment. In that manner, the Self-Assessment of the invention is able to give more personalized—and thus more useful—results better than any of the prior art.

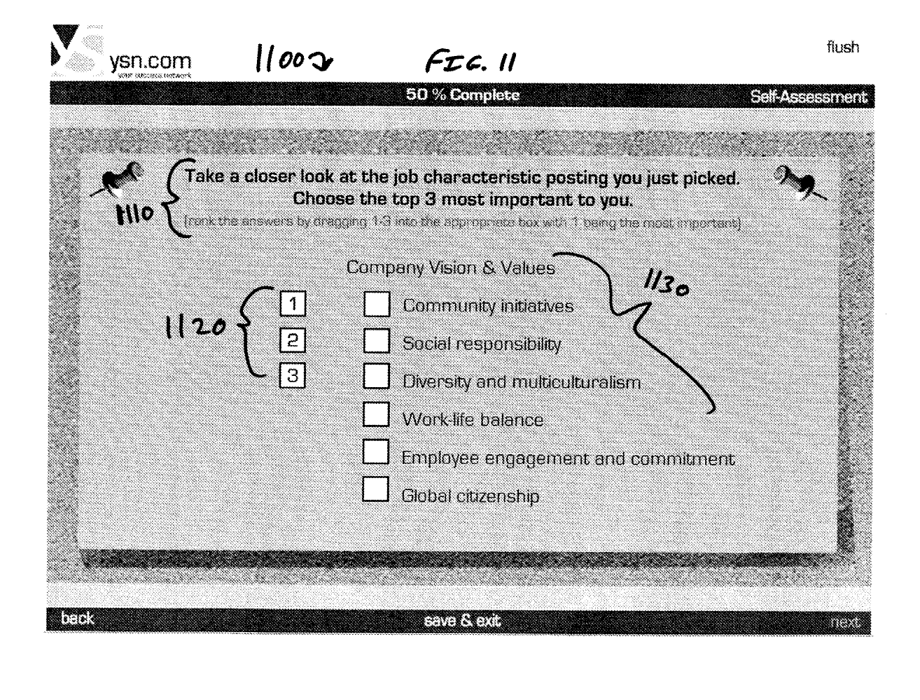

FIG. 11 is a screen shot from an internet browser that has accessed a single posting page 1100 from the YSN Self-Assessment System in one embodiment of the invention. On this page, there are instructions 1110, rank-ordinals 1120, and characteristics to be rank-ordered 1130, contained on what appears to be one of the posted notes from said posting board. These pages of the Self-Assessment enable the user to “drill-down” and provide more detailed information on specific job characteristics, as requested, and to be queried in greater detail about the broader categories of likes, dislikes, and interests. These characteristics help to determine for which types of companies the user may be best suited.

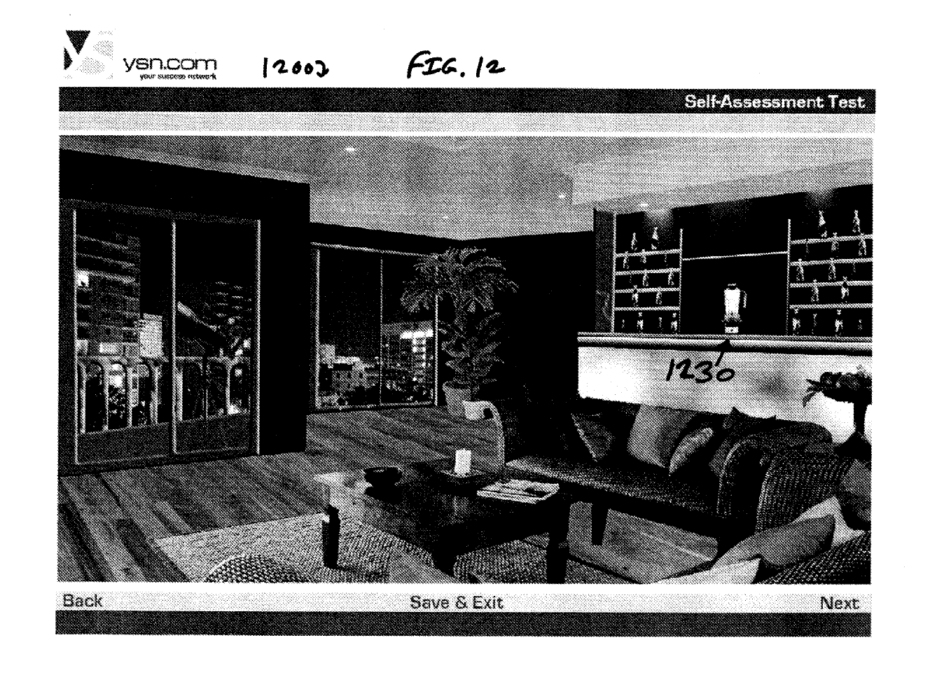

FIG. 12 is a screen shot from an internet browser that has accessed the “Penthouse With Smoothie Bar” 1200 from the YSN Self-Assessment System in one embodiment of the invention. The scene features a Smoothie Bar to blend critical personal elements together 1230.

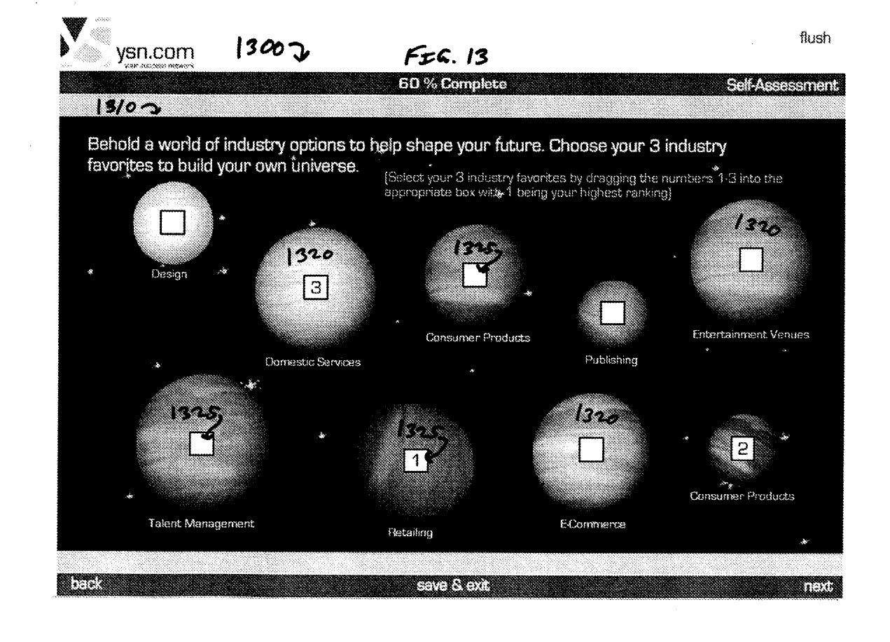

FIG. 13 is a screen shot from an internet browser that has accessed the “Master Your Universe” screen 1300 from the YSN Self-Assessment System in one embodiment of the invention. This screen provides instructions 1310, industries to be rank-ordered 1320 represented by spaces in the shape of planets, each of which is labeled with a different industry, and ranking spaces 1325 in which will be placed rank-ordinals. The industries are served up based on each individual user's selections from the magazine rack. Each person who takes the assessment receives customized results determined by their own selections.

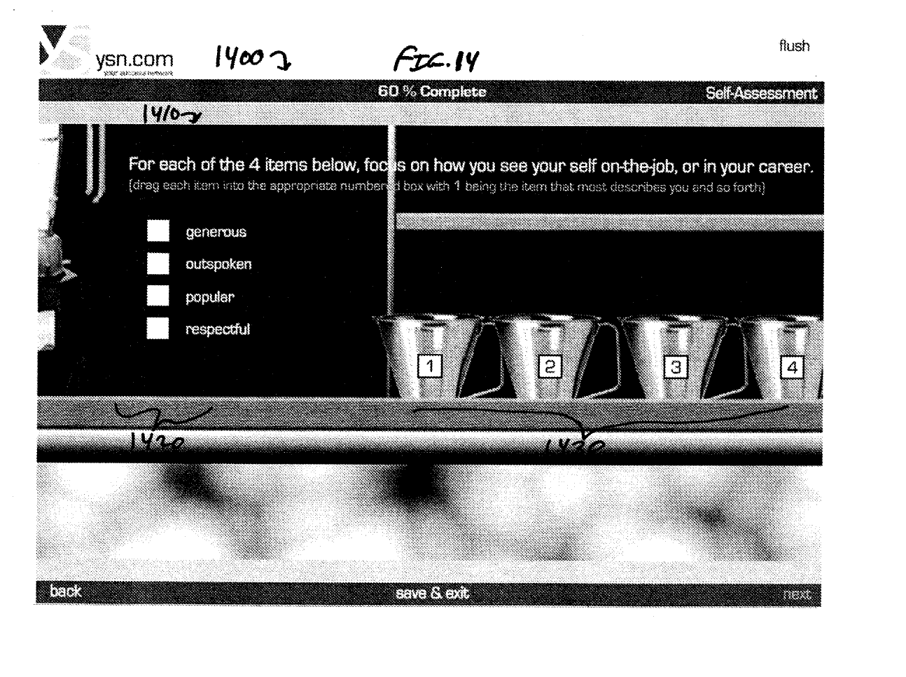

FIG. 14 is a screen shot from an internet browser that has accessed the “Smoothie Bar” 1400 from the YSN Self-Assessment System in one embodiment of the invention. This screen provides instructions 1410, traits or characteristics to be rank-ordered 1420 represented by dragging and dropping rank-ordinals, and rank-ordinals represented by objects in the shape of bar mixing cups 1430.

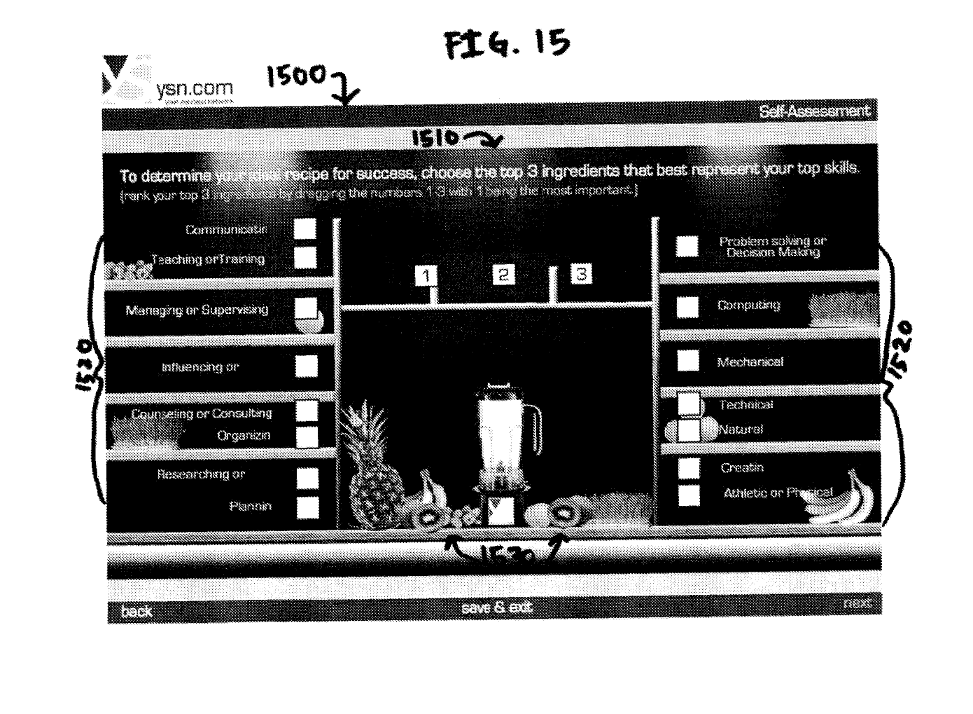

FIG. 15 is a screen shot from an internet browser that has accessed the “Wet Bar Blender Selection Scene” 1500 from the YSN Self-Assessment System in one embodiment of the invention. This screen provides instructions 1510, traits or skills to be rank-ordered 1520 represented by various mixers, and rank-ordinals represented by objects in the shape of bar blending cups 1530 to be put in a blender 1540. These skills may be used by the employment based system for employers to identify potential candidates.

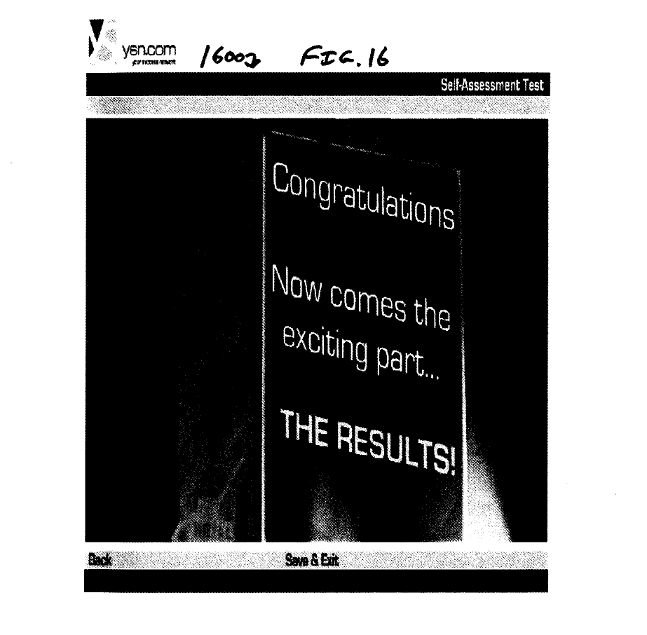

FIG. 16 is a screen shot from an internet browser that has accessed the Conclusion Screen 1600 from the YSN Self-Assessment System in one embodiment of the invention. Once the Self Assessment has been completed, the results are computed and are ready to be distributed to the particular user, they will be available in a Report that can be sent to the user, or may be accessed from the user's own page through a link such as 320 in FIG. 3.

What is claimed is:

1. A computer-based system for performing a self-assessment, comprising:
a system for the collection of a user's answers and responses to a series of questions and prompts;
a system for the production of a self-assessment report, said self-assessment report being produced based upon said user's answers and responses to said series of questions and prompts and said self-assessment report containing recommendations related to one or more classifications;
said one or more classifications being related to one or more of the following: vocational activities, avocational activities, interests, ambitions, hobbies, plans, past activities or other such activities;
an internet-based system for providing information about said user's classifications to one or more other users of the system; said other users of the system sharing one or more of said classifications with said user such that said other users may aid in the process of said self-assessment.

2. A system for performing a self-assessment according to claim 1, wherein said system further comprises a means for searching for other users based upon said classifications.

3. A system for performing a self-assessment according to claim 1, wherein said system further comprises a means for storing and presenting personal profiles and portfolios for said users as part of said system.

4. A system for performing self-assessment according to claim 3, wherein said means for storing and presenting personal profiles comprises a means for storing and presenting a list of other similar users for each user.

5. A system for performing self-assessment according to claim 1, wherein said system further comprises a means for said user to participate in one or more internet-based discussion groups.

6. A system for performing self-assessment according to claim 1, wherein said system further comprises a means for said user to access an informational library of industry questions and answers.

7. A system for performing self-assessment according to claim 6, wherein said informational library comprises information pertaining to said classifications.

8. A system for performing self-assessment according to claim 1, wherein said system comprises a means for encouraging interaction among said users.

9. An internet-based website, comprising:
a web page for the collection of a user's answers and responses to a series of questions and prompts;
a web page for the production of a self-assessment report, said self-assessment report being produced based upon said user's answers and responses to said series of questions and prompts and said self-assessment report containing recommendations related to one or more classifications;
said one or more classifications being related to one or more of the following: vocational activities, avocational activities, interests, ambitions, hobbies, plans, past activities or other such activities;
a web page for providing information about said user's classifications to one or more other users of the system; said other users of the system sharing one or more of said classifications with said user such that said other users may aid in the process of self-assessment.

10. A website according to claim 9, wherein said website further comprises a means for searching for other users based upon said classifications.

11. A website according to claim 9, wherein said system further comprises a means for storing and presenting personal profiles and portfolios for said user as part of said website.

12. A website according to claim 11, wherein said means for storing and presenting personal profiles comprises a means for storing and presenting a list of other preferred users for each user.

13. A website according to claim 9, wherein said website further comprises a means for said user to participate in one or more internet-based discussion groups.

14. A website according to claim 9, wherein said website further comprises a means for said user to access an informational library.

15. A website according to claim 14, wherein said informational library comprises information pertaining to said classifications.

16. A website according to claim 9, wherein said website comprises a means for encouraging interaction among said users.

17. A computer-based method for performing self-assessment, comprising the following steps:
administering a self-assessment on users, said self-assessment comprising a user's answers and responses to a series of questions and prompts;
producing a self-assessment report, said self-assessment report being produced based upon said user's answers and responses to said series of questions and prompts and said self-assessment report containing recommendations related to one or more classifications;
said one or more classifications being related to one or more of the following: vocational activities, avocational activities, interests, ambitions, hobbies, plans, past activities or other such activities;
providing information over the internet about said user's classifications to one or more other users of the system; said other users of the system sharing one or more of said classifications with said user such that said other users may aid in the process of self-assessment.

18. A method for performing self-assessment according to claim 17, wherein said method further comprises searching for other users based upon said classifications.

19. A method for performing self-assessment according to claim 18, wherein said method further comprises storing and presenting personal profiles and portfolios for said users as part of said system.

20. A method for performing self-assessment according to claim 19, wherein said storing and presenting personal profiles means further comprises a means for storing and presenting a list of other preferred users for each user.

21. A method for performing self-assessment according to claim 17, wherein said method further comprises users participating in one or more internet-based discussion groups.

22. A method for performing self-assessment according to claim 17, wherein said method further comprises said users accessing an informational library of industry questions and answers.

23. A method for performing self-assessment according to claim 22, wherein said informational library comprises information pertaining to said classifications.

24. A method for performing self-assessment according to claim 17, wherein said method comprises encouraging interaction among said users.
